(19) United States
(12) Patent Application Publication
(10) Pub. No.: US 2008/0159693 A1
(43) Pub. Date: Jul. 3, 2008

(54) Coupling device

(76) Inventor: Yem-Yeu Chang, Puzih City (TW)

Correspondence Address: J.C. Patents, Suite 250, 4 Venture, Irvine, CA, 92618, US

(21) Appl. No.: 11/998,197

(22) Filed: Nov. 28, 2007

(30) Foreign Application Priority Data
Dec. 28, 2006 (TW) 95149452
Jun. 22, 2007 (TW) 96122439

(51) Int. Cl. G02B 6/26

(52) U.S. Cl. 385/31

(57) ABSTRACT

A coupling device including a reflective cavity, at least one light source, and a light guide plate is provided. The reflective cavity has an opening, and includes a top surface, a bottom surface, a first side surface, a second side surface, and an end surface opposite to the opening. The light source is disposed at a position of the end surface. A side surface of the light guide plate is connected with the opening, and a thickness of the light guide plate is smaller than that of the light source.

### CROSS-REFERENCE TO RELATED APPLICATION

This application claims the priority benefit of Taiwan application serial no. 95149452, filed Dec. 28, 2006 and serial no. 96122439, filed Jun. 22, 2007. The entirety of each of the above-mentioned patent applications is hereby incorporated by reference herein and made a part of this specification.

### BACKGROUND OF THE INVENTION

1. Field of the Invention

The present invention relates to a coupling device. More particularly, the present invention relates to a coupling device capable of solving the problem of insufficient luminance of a light guide plate caused by an over-low coupling efficiency when a thickness of the light guide plate is smaller than that of a light source, and capable of improving uniformity of light emission.

2. Description of Related Art

Liquid crystal displays (LCDs) are wildly used displays nowadays, such as 20 mobile phone, computer monitor, and TV. However, as the liquid crystal panel is not a self-light-emitting device, an LCD needs a backlight module as a light source to display normally. Currently, light emitting diodes (LED) have become a promising light source, and LCDs with edge-lit type LED backlight modules have the advantages of low energy consuming, light weight, and slim thickness. Therefore, most portable devices are equipped with edge-lit LCDs. A traditional edge-lit type backlight module includes light source, light guide plate, reflective sheet, and some optical sheets. The light guide plate in the backlight module converts a point light source or a linear light source to a uniform surface light source, so as to realize plane illumination. Reflective sheet and optical sheets are applied to enhance optical performance. FIG. 1 is a sectional view of the configuration of an LED light source and a light guide plate according to the conventional art. As the divergence angle of the light of the LED light source 104 is small, generally the LED light source 104 is directly disposed on a side of the light guide plate 102 for coupling light. As shown in FIG. 1, this structure enables most of the light 106 emitted by the LED light source 106 to enter the light guide plate 102, while another part of light 108 does not enter the light guide plate 102, thus causing loss.

In general, in a structure that uses the configuration of FIG. 1 to perform coupling, the ratio between the thickness of the LED light source to that of the light guide plate will affect the coupling efficiency that the light enters the light guide plate. The coupling efficiency is the ratio of a light flux entering the light guide plate to a light flux emitted by the light source. FIG. 2A is a diagram showing the relationship between the thickness ratio of the light guide plate/the LED light source and the coupling efficiency according to the conventional art. When the thickness of the LED light source is smaller than or equal to that of the light guide plate, the coupling efficiency is about 90%. However, when the thickness of the light guide plate is reduced to 60% of the thickness of the light source, the coupling efficiency is reduced to about 50%.

In order to guide the light of the LED light source to the light guide plate more effectively, normally, the light guide plate having a thickness greater than or equal to that of the LED light source is used. Thus, the thickness of the LED light source will limit the thinnerization of the light guide plate. Therefore, when it intends to make an ultra-slim or flexible light guide plate, the over-low coupling efficiency will lead to the problem of insufficient luminance of the light guide plate, thus further influencing the performance of the display device.

Moreover, techniques related to the above description have been disclosed in some patents, for example, U.S. Pat. No. 5,262,968, U.S. Pat. No. 4,597,030, US 2005/0259939, and JP 11,232,921, the entire content of these patents is incorporated herein by reference. However, these patents still have some defects. For example, US2005/0259939 has disclosed a wedge-shaped coupling structure. It is known from the result of simulation analysis that when the thickness of the light guide plate is 60% of that of the light source, the coupling efficiency is about 70%. However, the wedge-shaped structure has difficulty in relatively positioning the light source and the light guide plate, and the technology for fabricating the light guide plate of the wedge-shaped structure is complicated. In other patents, the coupling architecture with a thin light guide plate also has the defect that the coupling structure occupies too much space or the light out-coupling structure of the light guide plate is difficult to design.

In addition, when the conventional structure in FIG. 1 is used for coupling, the light emission problem of non-uniform bright or dark bands as shown in FIG. 2B may occur at the coupling end surface of the light guide plate 102 adjacent to the LED light source 104, which lowers the uniformity of light emission of the light guide plate, and influences the performance of the display device. Though techniques related to the above problem have been disclosed in U.S. Pat. No. 6,568,822 and US 2004/0170011, the problem still cannot be effectively solved.

### SUMMARY OF THE INVENTION

The present invention is directed to a coupling device capable of solving the problem of insufficient luminance of a light guide plate caused by an over-low coupling efficiency when a thickness of the light guide plate is smaller than a thickness of the light source and alleviating the problem of non-uniform light or dark bands at a coupling end surface of the light guide plate.

The present invention provides a coupling device, which includes a reflective cavity, at least one light source, and a light guide plate. The reflective cavity has an opening, and includes a top surface, a bottom surface, a first side surface, a second side surface, and an end surface opposite to the opening. The light source is disposed at a position of the end surface. A side surface of the light guide plate is connected with the opening, and a thickness of the light guide plate is smaller than that of the light source.

As described above, a maximum thickness of the reflective cavity of the coupling device is substantially equal to that of the light source. The top surface and the bottom surface of the reflective cavity are mirror reflectors. Reflective characteristics of the first side surface, the second side surface, and the end surface of the reflective cavity can be the same or different, and can be mirror reflectors or scattering reflectors. Moreover, the top surface and the bottom surface of the reflective cavity can have the same shape or different shapes, for example, planes, arc surfaces, or multi-slope surfaces.

The light source of the coupling device is an LED light source. For example, the light source is disposed outside the reflective cavity and located on the end surface, and the end surface has an opening that allows the incidence of light of the light source. In addition, the light source can be disposed inside the reflective cavity, and is located on one side of the end surface. The light source can also be disposed on the end surface, and a portion of the light source is located outside the reflective cavity. Moreover, the light guide plate of the coupling device can be further embedded inside the reflective cavity.

The present invention further provides a coupling device, which includes a reflective cavity, at least one light source, a light guide plate, and a light spreading element. The reflective cavity has an opening. The reflective cavity includes a top surface, a bottom surface, a first side surface, a second side surface, and an end surface opposite to the opening. Moreover, the light source is disposed at a position of the end surface. A side surface of the light guide plate is connected with the opening, and a thickness of the light guide plate is smaller than that of the light source. The light spreading element is disposed inside the reflective cavity, and a side of the light spreading element adjacent to the light source has a first rough surface, and the other side of the light spreading element has a second rough surface.

The first rough surface of the light spreading element is a depression, a protrusion, a surface coated with micro particles, a hazed surface, or a combination thereof. The depression is, for example, a rectangular groove, a trapezoidal groove, an arc groove, a V-shaped groove, or a combination thereof. The protrusion is, for example, a rectangular pillar, a trapezoidal pillar, an arc pillar, a V-shaped pillar, or a combination thereof. Moreover, the second rough surface of the light spreading element is a depression, a protrusion, a surface coated with micro particles, a hazed surface, a subwavelength antireflection surface, or a combination thereof. The depression is, for example, a rectangular groove, a trapezoidal groove, an arc groove, a V-shaped groove, or a combination thereof. The protrusion is, for example, a rectangular pillar, a trapezoidal pillar, an arc pillar, a V-shaped pillar, or a combination thereof. The light spreading element is a transparent material plate made of polymethyl methacrylate or polycarbonate.

The coupling device of the present invention has a reflective cavity between the light guide plate and the light source, such that the light that cannot be guided to the light guide plate originally is guided to the light guide plate after multiple times of reflection or scattering, so as to improve the coupling efficiency. Therefore, the coupling device of the present invention solves the problem of insufficient luminance of the light guide plate caused by the low coupling efficiency when the thickness of the light guide plate is smaller than that of the light source. Moreover, the light spreading element can be further disposed inside the reflective cavity of the coupling device of the present invention, so as to spread the light of the LED light source. Thus, the problem of non-uniform luminance of light or dark bands at a front end of the light guide plate is solved. In addition, in the coupling device structure of the present invention, the light guide plate can be embedded into the reflective cavity, so as to prevent the problem that the coupling efficiency is reduced caused by misalignment between the light source and the light guide plate.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a sectional view of the configuration of an LED light source and a light guide plate according to the conventional art.

FIG. 2A is a diagram showing the relationship between the thickness ratio of the light guide plate/the LED light source and the coupling efficiency of the conventional art.

FIG. 2B is a schematic view of light emission of the light guide plate when the conventional structure in FIG. 1 is used for coupling.

FIG. 3 is a schematic perspective view of the coupling device according to the first embodiment of the present invention.

FIGS. 4, 5A, 5B, and 5C are schematic sectional views of coupling devices according to other embodiments of the present invention respectively.

FIG. 6 is a schematic sectional view of the coupling device according to the second embodiment of the present invention.

FIG. 7 is a schematic sectional view of the coupling device according to the third embodiment of the present invention.

FIG. 8 is a schematic sectional view of the coupling device according to the fourth embodiment of the present invention.

FIGS. 9A, 9B, 9C, and 9D are schematic sectional views of the coupling device according to the fifth embodiment of the present invention.

FIG. 10A is a schematic sectional view of the coupling device according to the sixth embodiment of the present invention.

FIGS. 10B-10Q are schematic views of the light spreading element according to embodiments of the present invention.

FIGS. 11A and 11B are diagrams showing the relationship between the coupling efficiency and the length of the reflective cavity obtained by testing the coupling device structure of FIG. 3.

FIG. 12 is a diagram showing the relationship between the coupling efficiency and the shape of the reflective cavity obtained by testing the coupling device structure of FIGS. 5A and 5C.

FIG. 13 is a diagram showing the relationship between the coupling efficiency and the shape of the reflective cavity obtained by testing the coupling device structure of FIG. 5B.

FIG. 14A is a diagram showing the illuminance relationship of the coupling device without the light spreading element.

FIG. 14B is a diagram showing the illuminance relationship of the coupling device with the light spreading element.

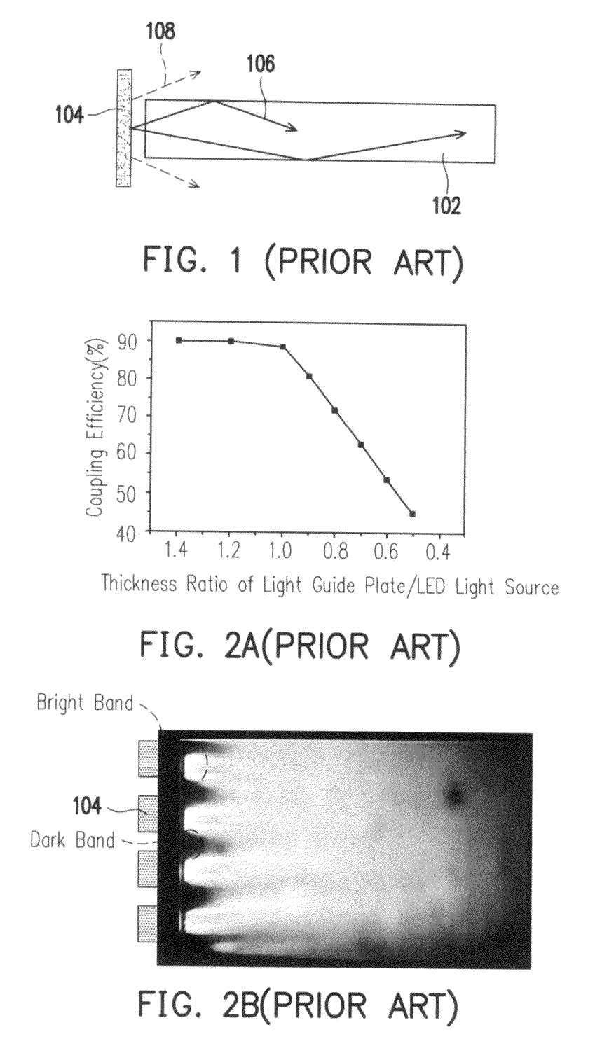

### DESCRIPTION OF EMBODIMENTS

The present invention provides a coupling device for solving the problem that the coupling efficiency reduces greatly when a thickness of the light guide plate is smaller than that of a light source. Here, the “thickness of the light guide plate” refers to a thickness of a light incident surface of the light guide plate, and the “thickness of the light source” refers to a thickness of a light-emitting section of the light source. Therefore, the present invention is applicable to an ultra-thin light guide plate or a slim flexible light guide plate, so as to prevent the problem of insufficient luminance of the light guide plate caused by the low coupling efficiency.

The coupling device of the present invention mainly includes a reflective cavity, a light guide plate, and at least one light source. The present invention uses the reflective cavity of the coupling device to guide the light that cannot be guided to the light guide plate originally to the light guide plate after multiple times of reflection or scattering, so as to improve the coupling efficiency.

Several embodiments are given below to illustrate the structure of the coupling device of the present invention in detail. In the following embodiments, the same components have the same reference numbers, and the repeated descriptions will be omitted herein.

### The First Embodiment

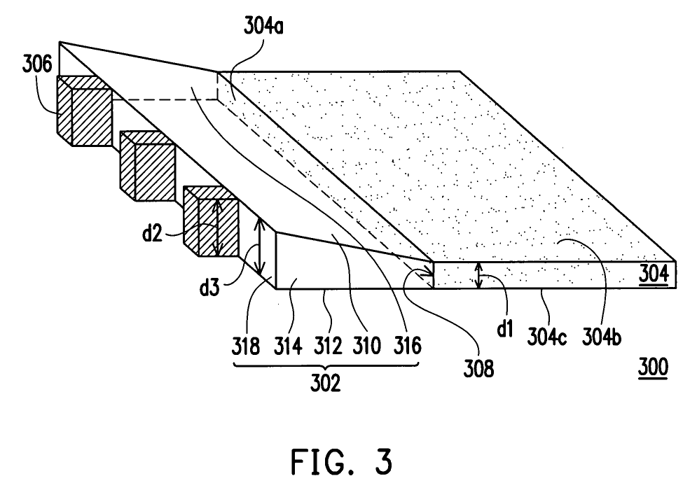

FIG. 3 is a schematic perspective view of the coupling device according to the first embodiment of the present invention. The coupling device 300 of this embodiment includes a reflective cavity 302, a light guide plate 304, and light sources 306.

The reflective cavity 302 has an opening 308, and includes a top surface 310, a bottom surface 312, a first side surface 314, a second side surface 316 and an end surface 318 opposite to the opening 308. The top surface 310 and the bottom surface 312 of the reflective cavity 302 are mirror reflectors, and the first side surface 314, the second side surface 316, and the end surface 318 can have the same or different reflective characteristics, i.e., can be mirror reflectors or scattering reflectors. In addition, the top surface 310 and the bottom surface 312 of the reflective cavity 302 are planes in this embodiment.

Moreover, the methods for fabricating the reflective cavity 302 include, but are not limited to, the following methods. For example, a method for fabricating the reflective cavity includes cutting out the graphic that the reflective cavity 302 is unfolded from a complete reflective plate, folding the cut graphic, and then fabricating each surface of the reflective cavity 302 to a mirror reflector or a scattering reflector according to different designs of each surface. For example, another method for fabricating the reflective cavity includes cutting out the graphic that the reflective cavity 302 is unfolded from a complete board, folding the cut graphic, pasting reflective material layers thereon, and then fabricating each surface of the reflective cavity 302 to a mirror reflector or a diffusive reflector according to different designs of the each surface. Definitely, the method for fabricating the reflective cavity 302 can include fabricating each surface of the reflective cavity 302 first, and then assembling the surfaces. For example, the material of the diffusive reflectors of the reflective cavity 302 can be a mixture of a white inorganic salt such as aluminum oxide, titanium oxide, or barium sulfate and a bonding resin, or can be a white resin material such as modified polycarbonate (PC) or polyphthalamide (PPA), and the material of the mirror reflectors can be a metal such as indium, tin, aluminum, gold, platinum, zinc, or silver, or an alloy thereof. The mirror cab also be a metal film deposited onto the plastic sustrate, i.e. commercialized silver reflective sheets.

In addition, a side surface 304a of the light guide plate 304 is connected with the opening 308 of the reflective cavity 302. Moreover, a thickness d1 of the light guide plate 304 is smaller than a thickness d2 of the light sources 306. It should be noted that a maximum thickness d3 of the reflective cavity 302 is substantially equal to the thickness d2 of the light sources 306. The light guide plate 304 is a common light guide plate applied in the display element industry. The light guide plate 304, for example, can be fabricated with a transparent material such as polymethyl methacrylate (PMMA) or polycarbonate (PC), and is in a substantially plate-like flat shape. Moreover, the side surface 304a of the light guide plate 304 functions as a light incident surface, while a top surface 304b and a bottom surface 304c function as light propagation and out-coupling to form a uniform surface illumination.

In this embodiment, the light sources 306 are LED light sources. The light sources 306 are disposed on a side of the reflective cavity 302 at positions opposite to the opening 308. In detail, the light sources 306 are disposed outside the reflective cavity 302 and on the end surface 318 of the reflective cavity 302, and the end surface 318 has an opening (not shown) that allows the incidence of the light of the light sources 306. In this embodiment, three light sources 306 are taken as an example. However, the present invention has no limitation on the number of the light sources.

The coupling device of this embodiment can guide the light emitted by the light sources 306 that cannot be directly guided to the light guide plate 304 to the light guide plate 304 through multiple times of reflection or scattering by the reflective cavity 302, so as to improve the coupling efficiency.

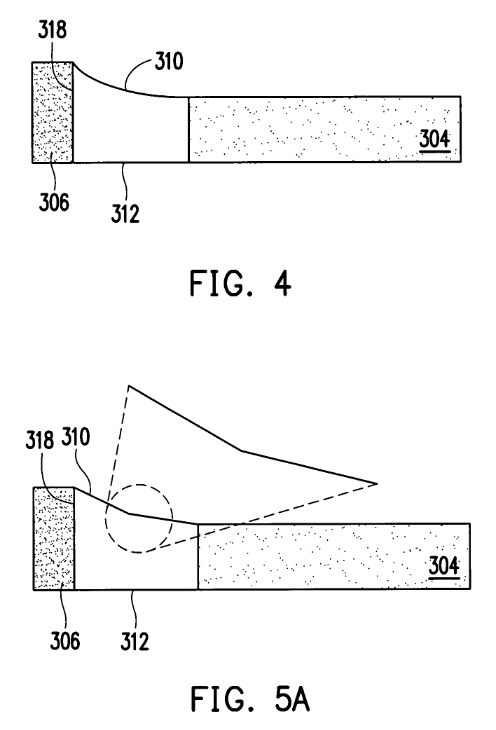

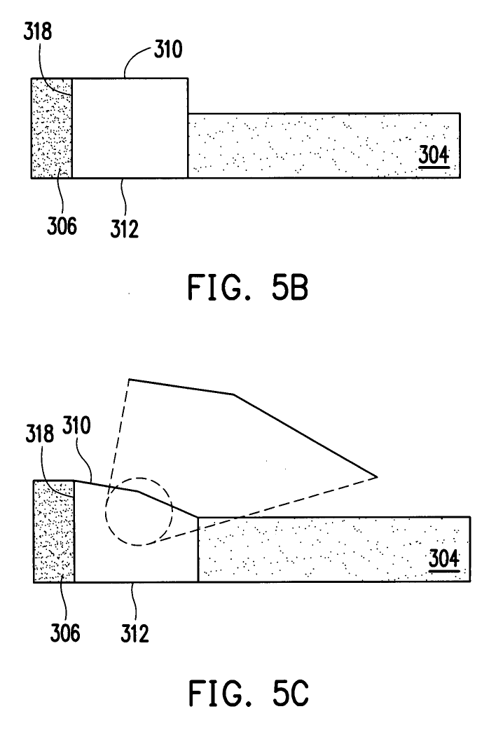

In the first embodiment, the top surface 310 and the bottom surface 312 of the reflective cavity 302 are planes, and can also be arc surfaces or multi-slope surfaces. In addition, the top surface 310 and the bottom surface 312 of the reflective cavity 302 can have different shapes, and can be plane, arc surfaces, or multi-slope surfaces. As shown in FIG. 4, the top surface 310 of the reflective cavity 302 is an arc surface, and the bottom surface 312 is a plane. As shown in FIGS. 5A, 5B, and 5C, the top surface 310 of the reflective cavity 302 is a multi-slope surface, and the bottom surface 312 is a plane. Moreover, FIG. 4 and FIGS. 5A-5C only show examples to illustrate the present invention, but are not used to limit the present invention.

### The Second Embodiment

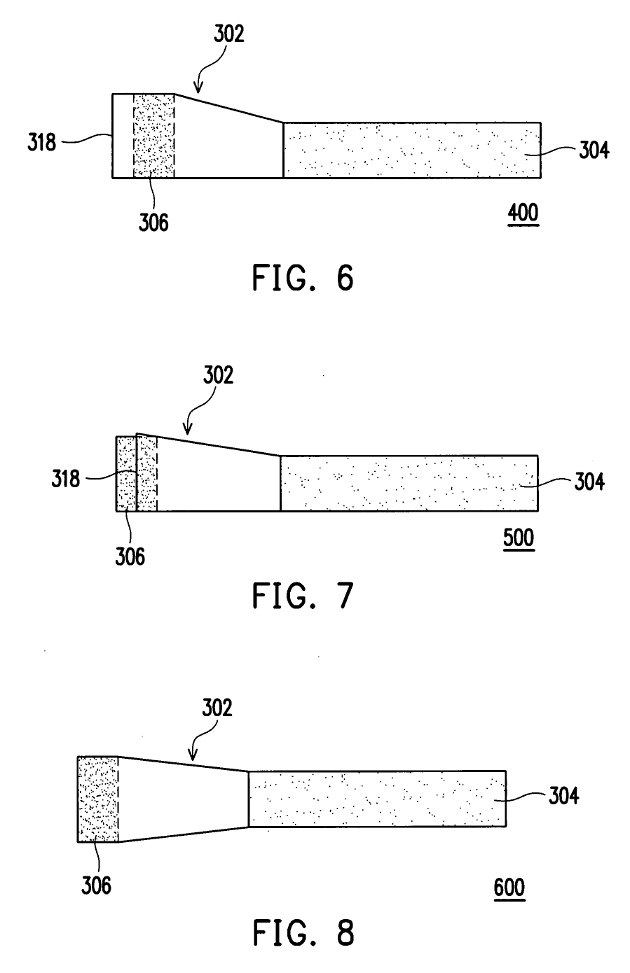

FIG. 6 is a schematic sectional view of the coupling device according to the second embodiment of the present invention. The coupling device 400 of this embodiment is similar to the coupling device 300 of the first embodiment, except that the light sources 306 are disposed inside the reflective cavity 302, and are disposed on one side of the end surface 318.

### The Third Embodiment

FIG. 7 is a schematic sectional view of the coupling device according to the third embodiment of the present invention. The coupling device 500 of this embodiment is similar to the coupling device 300 of the first embodiment, except that the light sources 306 are disposed on the end surface 318, and a part of the light sources 306 are disposed outside the reflective cavity 302.

### The Fourth Embodiment

FIG. 8 is a schematic sectional view of the coupling device according to the fourth embodiment of the present invention. The coupling device 600 of this embodiment is similar to the coupling device 300 of the first embodiment, except that the coupling device 600 of this embodiment can fill a reflective scattering substance among the light sources 306 by means of integrated packaging to replace the end surface 318, so as to form the reflective cavity 302 after the material is combined with other reflective components.

### The Fifth Embodiment

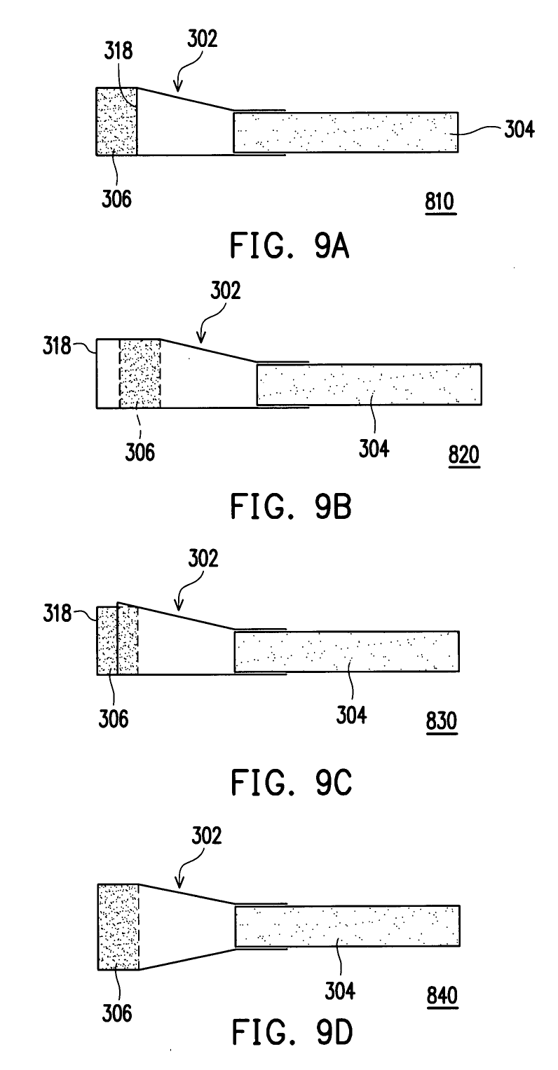

FIGS. 9A, 9B, 9C, and 9D are schematic sectional views of the coupling device according to the fifth embodiment of the present invention. The coupling devices 810, 820, 830, and 840 of this embodiment are similar to the coupling devices 300, 400, 500, and 600 of the first, second, third, and fourth embodiments respectively, except that the light guide plate 304 can be embedded into the reflective cavity 302. In addition, by the use of the structure that the light guide plate is embedded into the reflective cavity, the problem that the coupling efficiency is reduced caused by misalignment between the light source and the light guide plate can also be avoided.

In addition to the above embodiments, the present invention can also have other implementations. Besides the reflective cavity, the light guide plate, and at least one light source, a light spreading element can be further disposed inside the reflective cavity of the coupling device of the present invention. The light spreading element contributes to convert the point light source into a line light source, so as to solve the problem of non-uniform bright or dark bands near the coupling end surface of the light guide plate, and to improve the uniformity of illumination.

### The Sixth Embodiment

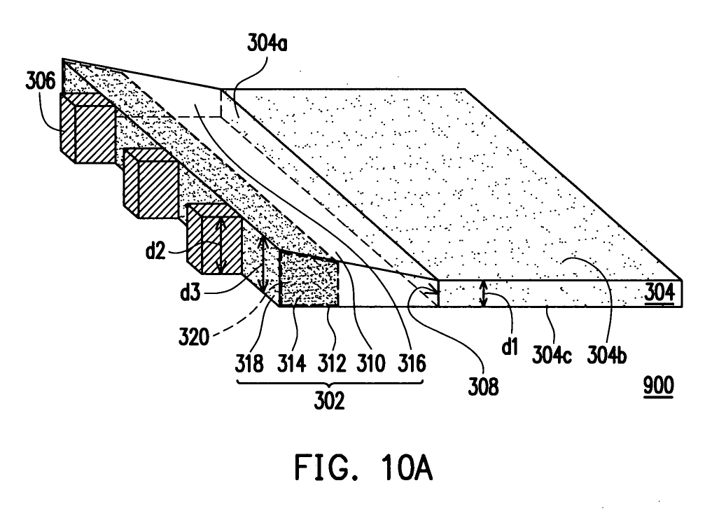

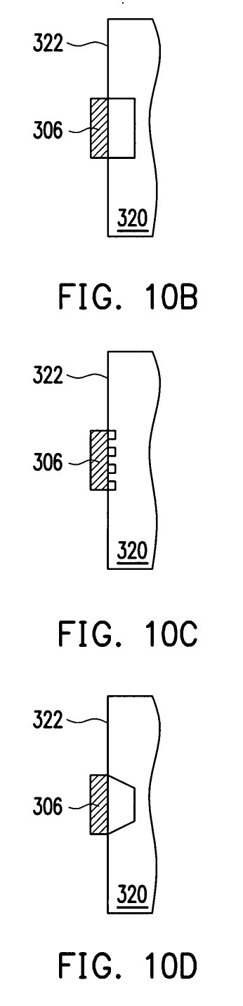

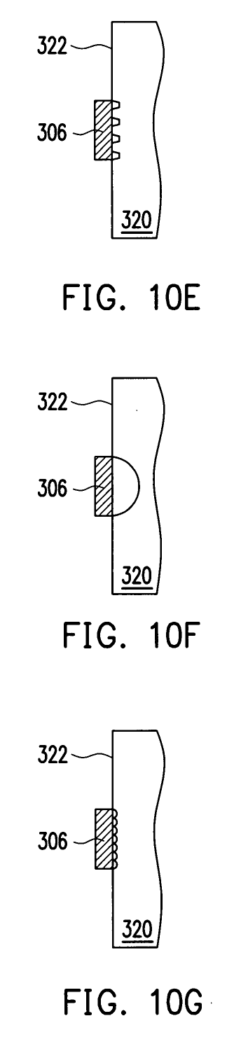

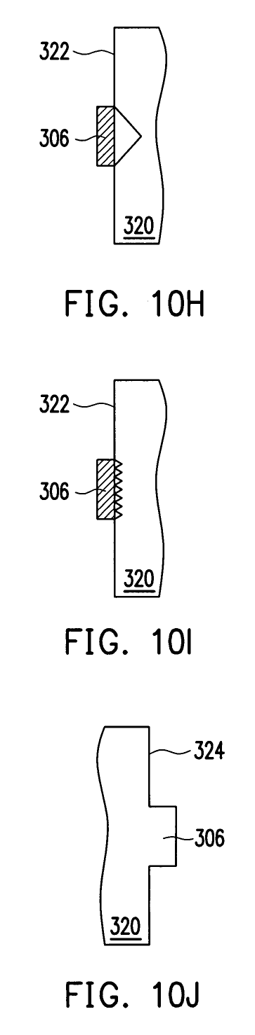

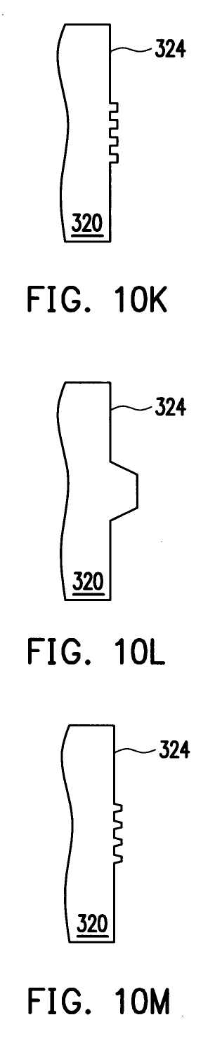

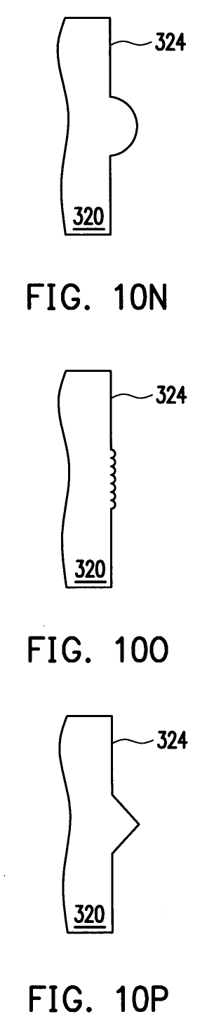

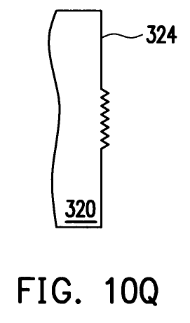

FIG. 10A is a schematic sectional view of the coupling device according to the sixth embodiment of the present invention. The coupling device 900 of this embodiment is similar to the coupling device 300 of this embodiment, while the difference lies in that a light spreading element 320 can be further disposed inside the reflective cavity 302 of the coupling device 900. The light spreading element 320 can be a transparent material plate, and the material of the transparent material plate is polymethyl methacrylate or polycarbonate, for example. In particular, a side of the light spreading element 320 adjacent to the light source 306 has a first rough surface 322 to expand the illuminant angle, and the side adjacent to the light guide plate 304 has a second rough surface 324 to enhance light transmittance.

The first rough surface 322 of the light spreading element 320 can be, for example, a depression, a protrusion, a surface coated with micro particles, a hazed surface, or a combination thereof. The second rough surface 324 of the light spreading element 320 can be, for example, a depression, a protrusion, a surface coated with micro particles, a hazed surface, a subwavelength antireflection surface, or a combination thereof. FIGS. 10B-10Q illustrate situations when the rough surfaces of the light spreading element 320 are depressions and protrusions, in which only the light source 306 and the light spreading element 320 are shown, and other components are omitted. The first rough surface 322 of the light spreading element 320 is a depression, for example, a rectangular groove (as shown in FIGS. 10B and 10C), a trapezoidal groove (as shown in FIGS. 10D and 10E), an arc groove (as shown in FIGS. 10F and 10G), a V-shaped groove (as shown in FIGS. 10H and 10I), or a combination thereof. The second rough surface 324 of the light spreading element 320 is a protrusion, for example, a rectangular pillar (as shown in FIGS. 10J and 10K), a trapezoidal pillar (as shown in FIGS. 10L and 10M), an arc pillar (as shown in FIGS. 10N and 10O), and a V-shaped pillar (as shown in FIGS. 10P and 10Q), or a combination thereof.

As described above, in the coupling devices 400, 500, 600, and 810-840 of the second, third, fourth, and fifth embodiments of the present invention, the light guide plate can also be further disposed inside the reflective cavity 302, so as to improve the uniformity of illumination. However, such modifications can be deduced from the above embodiment by persons skilled in the art, and will not be described herein again.

The shape of the light spreading element of the above embodiments can be designed in accordance with an interior shape of the reflective cavity. Moreover, the light spreading element can be rectangular or in other shapes that are easy to fabricate, and the interior shape of the reflective cavity can be modified appropriately. Certainly, persons skilled in the art can design the shapes of the light spreading element and the reflective cavity in consideration of the convenience of fabrication and the performance of the coupling device, and the details will not be described herein again.

It is known from the above description that the coupling device of the present invention can spread the light of the LED light source in addition to improving the coupling efficiency, thereby solving the problem of non-uniform luminance of bright or dark bands at a front end of the light guide plate.

Then, the coupling efficiency and the uniformity of illumination of the coupling device structure of the present invention will be illustrated.

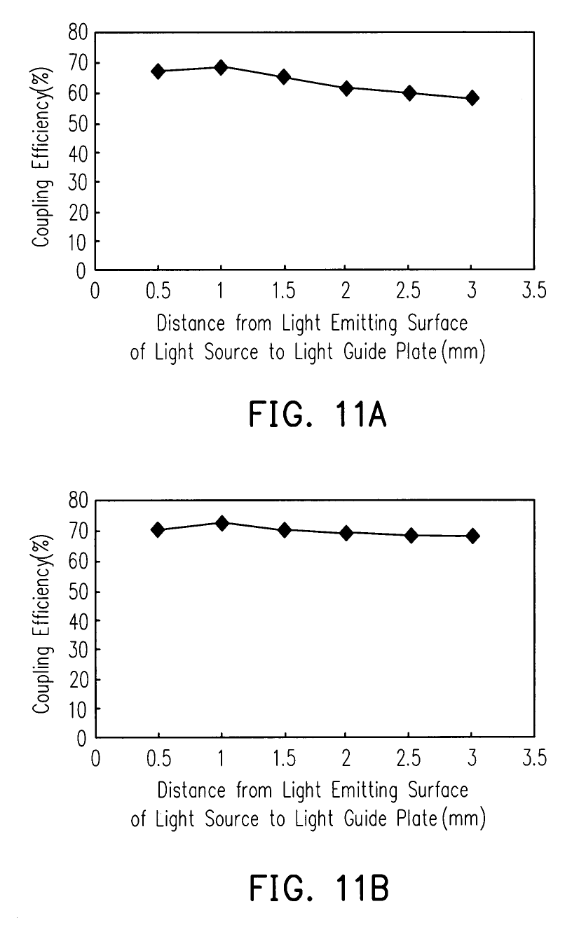

FIGS. 10A and 10B are diagrams showing the relationship between the coupling efficiency and the length of the reflective cavity (i.e., the distance from light emitting surfaces of the light sources to the light guide plate) obtained by testing the coupling structure of FIG. 3. The coupling devices of FIGS. 11A and 11B are tested under the conditions that the thickness of the light guide plate is 0.36 mm, the thickness of the light sources is 0.6 mm, and the top surface and the bottom surface are both mirror reflectors. The end surface of the coupling device of FIG. 11A is a mirror reflector, and the end surface of the coupling device of FIG. 11B is a scattering reflector.

It is known from FIG. 11B that X-axis is the distance from the light emitting surfaces of the light sources to the light guide plate, which can be also defined as the length of the reflective cavity, and Y-axis is the coupling efficiency (%). The length of the reflective cavity is between 0.5 mm and 3.0 mm, and the calculated coupling efficiency is about 60% to 70%. Similarly, it is known from FIG. 11B that the length of the reflective cavity is between 0.5 mm and 3.0 mm, and the calculated coupling efficiency is about 70%.

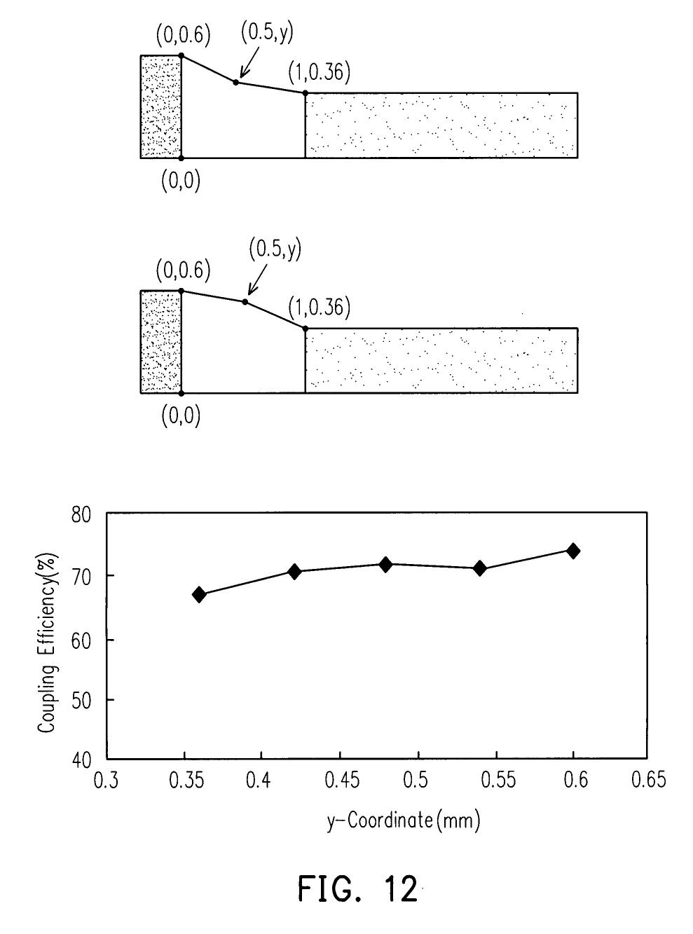

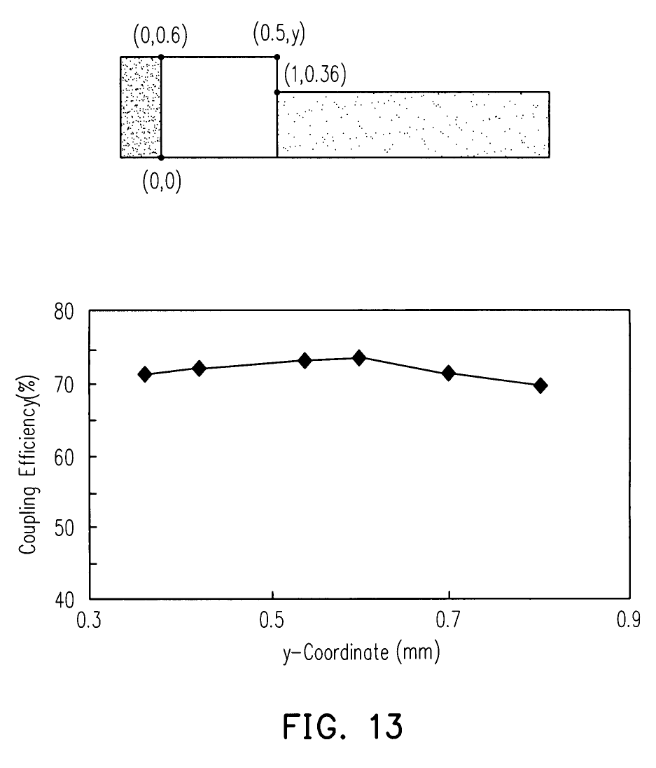

FIG. 12 is a diagram showing the relationship between the coupling efficiency and the shape of the reflective cavity obtained by testing the coupling structures of FIGS. 5A and 5C, and FIG. 13 is a diagram showing the relationship between the coupling efficiency and the shape of the reflective cavity obtained by testing the coupling structure of FIG. 5B. The coupling devices of FIGS. 12 and 13 are tested under the conditions that the thickness of the light guide plate is 0.36 mm, the thickness of the light sources is 0.6 mm, the length of the reflective cavity is 1 mm, the top surface and the bottom surface are both mirror reflectors, and the end surface is a scattering reflector. It is known from FIGS. 12 and 13 that when the top reflective surface or the bottom reflective surface is a multi-slope reflector, a high coupling efficiency can be obtained as well. When the structures of FIGS. 5B and 5C are used, the coupling efficiency of 70%-75% is obtained. When the structure of FIG. 5A is used, the coupling efficiency is lower, but is still higher than 65%.

As shown in the results of the above tests, the coupling efficiency of the coupling device of the present invention is up to about 70%, which is approximately equal to or even higher than the coupling efficiency of the prior patents.

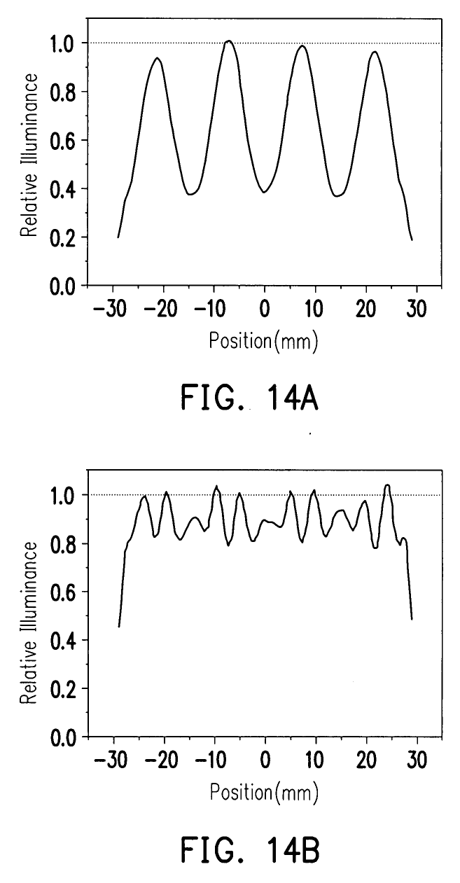

FIGS. 14A and 14B are diagrams showing the illuminance relationship of the coupling devices without and with the light spreading element respectively. As shown in FIG. 14A, the relative illuminance of the coupling device without the light spreading element is distributed non-uniformly. As shown in FIG. 14B, the uniformity of the relative illuminance of the coupling device with the light spreading element is up to about 80%. It is known from the comparison between FIGS. 14A and 14B that the light spreading element disposed inside the reflective cavity helps to solve the problem of non-uniform luminance of bright or dark bands at the front end of the light guide plate, and to improve the uniformity of illumination of the light guide plate.

To sum up, the coupling device of the present invention improves the coupling efficiency by the use of the reflective cavity. Moreover, the coupling device of the present invention is applicable to an ultra-thin or slim flexible light guide plate, so as to prevent the problem of insufficient luminance of the light guide plate caused by the low coupling efficiency. Furthermore, a light spreading element can be further disposed inside the reflective cavity of the coupling device of the present invention to spread the light of the LED light source, so as to solve the problem of non-uniform luminance of bright or dark bands at a front end of the light guide plate. In another aspect, in the coupling device structure of the present invention, the light guide plate can be embedded into the reflective cavity, so as to prevent the problem that the coupling efficiency is reduced caused by misalignment between the light source and the light guide plate.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A coupling device, comprising:
a reflective cavity, having an opening, and including a top surface, a bottom surface, a first side surface, a second side surface, and an end surface opposite to the opening;
at least one light source, disposed at a position of the end surface; and
a light guide plate, having a side surface connected with the opening, and a thickness smaller than that of the light source.

2. The coupling device as claimed in claim 1, wherein the top surface and the bottom surface are mirror reflectors.

3. The coupling device as claimed in claim 2, wherein a reflective characteristic of the first side surface is a mirror reflector or a scattering reflector.

4. The coupling device as claimed in claim 2, wherein a reflective characteristic of the second side surface is a mirror reflector or a scattering reflector.

5. The coupling device as claimed in claim 2, wherein a reflective characteristic of the end surface is a mirror reflector or a scattering reflector.

6. The coupling device as claimed in claim 1, wherein the top surface is a plane, an arc surface, or a multi-slope surface.

7. The coupling device as claimed in claim 1, wherein the bottom surface is a plane, an arc surface, or a multi-slope surface.

8. The coupling device as claimed in claim 1, wherein the light source is disposed outside the reflective cavity and located on the end surface, and the end surface has an opening that allows the incidence of light of the light source.

9. The coupling device as claimed in claim 1, wherein the light source is disposed inside the reflective cavity and located on one side of the end surface.

10. The coupling device as claimed in claim 1, wherein the light source is disposed on the end surface and a portion of the light source is disposed outside the reflective cavity.

11. The coupling device as claimed in claim 1, wherein a scattering reflective substance is filled among the light sources by means of integrated packaging to replace the end surface.

12. The coupling device as claimed in claim 1, wherein the light guide plate is further embedded inside the reflective cavity.

13. The coupling device as claimed in claim 1, wherein a maximum thickness of the reflective cavity is substantially equal to that of the light source.

14. The coupling device as claimed in claim 1, wherein the light source is an LED light source.

15. The coupling device as claimed in claim 1, further comprising:
a light spreading element, disposed inside the reflective cavity, wherein a side of the light spreading element adjacent to the light source has a first rough surface, and the other side of the light spreading element has a second rough surface.

16. The coupling device as claimed in claim 15, wherein the first rough surface is a depression, a protrusion, a surface coated with micro particles, a hazed surface, or a combination thereof.

17. The coupling device as claimed in claim 16, wherein the depression comprises a rectangular groove, a trapezoidal groove, an arc groove, a V-shaped groove, or a combination thereof.

18. The coupling device as claimed in claim 16, wherein the protrusion comprises a rectangular pillar, a trapezoidal pillar, an arc pillar, a V-shaped pillar, or a combination thereof.

19. The coupling device as claimed in claim 15, wherein the second rough surface is a depression, a protrusion, a surface coated with micro particles, a hazed surface, a subwavelength antireflection surface, or a combination thereof.

20. The coupling device as claimed in claim 19, wherein the depression comprises a rectangular groove, a trapezoidal groove, an arc groove, a V-shaped groove, or a combination thereof.

21. The coupling device as claimed in claim 19, wherein the protrusion comprises a rectangular pillar, a trapezoidal pillar, an arc pillar, a V-shaped pillar, or a combination thereof.

22. The coupling device as claimed in claim 15, wherein the light spreading element is a transparent material plate.

23. The coupling device as claimed in claim 22, wherein a material of the transparent material plate comprises polymethyl methacrylate or polycarbonate.

24. The coupling device as claimed in claim 15, wherein the top surface and the bottom surface are mirror reflectors.

25. The coupling device as claimed in claim 24, wherein a reflective characteristic of the first side surface is a mirror reflector or a scattering reflector.

26. The coupling device as claimed in claim 24, wherein a reflective characteristic of the second side surface is a mirror reflector or a scattering reflector.

27. The coupling device as claimed in claim 24, wherein a reflective characteristic of the end surface is a mirror reflector or a scattering reflector.

28. The coupling device as claimed in claim 15, wherein the top surface is a plane, an arc surface, or a multi-slope surface.

29. The coupling device as claimed in claim 15, wherein the bottom surface is a plane, an arc surface, or a multi-slope surface.

30. The coupling device as claimed in claim 15, wherein the light source is disposed outside the reflective cavity and located on the end surface, and the end surface has an opening that allows the incidence of light of the light source.

31. The coupling device as claimed in claim 15, wherein the light source is disposed inside the reflective cavity and located on one side of the end surface.

32. The coupling device as claimed in claim 15, wherein the light source is disposed on the end surface, and a portion of the light source is disposed outside the reflective cavity.

33. The coupling device as claimed in claim 15, wherein a scattering reflective substance is filled among the light sources by means of integrated packaging to replace the end surface.

34. The coupling device as claimed in claim 15, wherein the light guide plate is further embedded inside the reflective cavity.

35. The coupling device as claimed in claim 15, wherein a maximum thickness of the reflective cavity is substantially equal to that of the light source.

36. The coupling device as claimed in claim 15, wherein the light source is an LED light source.
